(19) United States
(12) Patent Application Publication
(10) Pub. No.: US 2023/0260064 A1
(43) Pub. Date: Aug. 17, 2023

(54) METHODS AND SYSTEMS FOR SUPPLY CHAIN ENTITY VALIDATION

(71) Applicant: Tru Identity, Inc., New York, NY (US)

(72) Inventors: Hugo Aaron Pakula, Philadelphia, PA (US); Michael Adrian Pakula, New York, NY (US); Lucas Ege, Browns Valley, CA (US)

(21) Appl. No.: 18/110,731

(22) Filed: Feb. 16, 2023

Related U.S. Application Data
(60) Provisional application No. 63/311,411, filed on Feb. 17, 2022.

(51) Int. Cl. G06Q 50/18

(52) U.S. Cl. CPC G06Q 50/184

(57) ABSTRACT

An entity validation platform maintains a database of unique identifiers for entities participating in one or more supply chains. Each unique identifier can be used to validate an identity of a respective entity participating in the one or more supply chains. A request is received by the platform for assignment of a unique identifier for a supply chain entity. The request can include an indication of a name associated with the supply chain entity and an indication of products and/or services associated with the supply chain entity. The platform can validate an entity ownership structure associated with the supply chain entity and/or a geographic location at which the supply chain entity is operating. In response to validating the entity ownership structure and the geographic location for the supply chain entity, the platform can update the database to assign the unique identifier to the supply chain entity.

### RELATED APPLICATIONS

This application is related to and claims the benefit of U.S. Provisional Patent Application No. 63/311,411, filed Feb. 17, 2022 titled “Method and Systems For Supply Chain Entity Validation,” the entirety of which is incorporated herein by reference.

### TECHNICAL FIELD

Embodiments of the present disclosure relate, in general, to methods and systems for supply chain entity validation.

### BACKGROUND

Different types of entities can participate in a supply chain (e.g., a product supply chain, a service supply chain, etc.). For example, a design and/or development entity can design and/or develop a product to be introduced into a product supply chain, a manufacturing entity can manufacture the products, a transportation entity (e.g., a shipping entity) can transport the products between other entities of the product supply chain, a logistics entity can coordinate transportation of the products between the supply chain entities, a seller entity can sell the products to consumers (e.g., individual consumers, organizations, other supply chain entities, etc.), and so forth. Some supply chains (e.g., global supply chains, etc.) can include a significant number of supply chain entities, where some entities operate in different countries or jurisdictions. Conventional systems do not enable supply chain authorities (e.g., customs authorities, etc.) to track information for each entity associated with products passing through a supply chain. The lack of entity information for a significant number of products transported between countries or jurisdiction makes it difficult for supply chain authorities to identify and stop malicious supply chain actors that are trafficking counterfeit and/or unauthorized products into a given country or jurisdiction.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a method is disclosed for supply chain entity validation. A database of unique identifiers for entities associated with one or more supply chains is maintained by an entity validation platform. Each unique identifier can be used to validate an identity associated with a respective entity associated with the one or more supply chains. A request is received by the entity validation platform for assignment of a unique identifier for a supply chain entity. The request includes information associated with the supply chain entity, the information including at least an indication of a name associated with the supply chain entity and an indication of at least one of a product or a service associated with the supply chain entity. The entity validation platform validates, for the supply chain entity, an entity ownership structure associated with the supply chain entity and a geographic location where the supply chain entity is operating. The entity ownership structure and/or the geographic location is validated based on verified information included in one or more additional databases accessible by the entity validation platform, wherein the verified information included in the one or more additional databases is verified by one or more trusted supply chain information entities. In response to validating the entity ownership structure and the geographic location for the supply chain entity, the database is updated by the entity validation platform to assign the unique identifier to the supply chain entity, Updating the database to assign the unique identifier to the supply chain entity indicates to a supply chain authority accessing the database that the supply chain entity is a validated supply chain entity that can participate in the one or more supply chains.

In other or similar implementations, a system including a memory and a processor connected to the memory is disclosed. The processor is to perform operations including receiving, from a client device connected to an entity validation platform, a request for at least one of a product or a service to be added to a supply chain by a first supply chain entity. The request includes a first unique identifier issued to the first supply chain entity by the entity validation platform. The operations further include identifying an entry of an entity validation database that corresponds to the at least one of the product or the service. The entity validation database is maintained by the entity validation platform. The operations further include determining whether the first unique identifier issued to the first supply chain entity corresponds to a second unique identifier for a second supply chain entity indicated by the identified entry of the entity validation database. The operations further include, responsive to determining that the first unique identifier does not correspond to the second unique identifier, obtaining information associated with the second supply chain entity. The information corresponds to an entity ownership structure associated with the second supply chain entity, an intellectual property ownership status associated with the second supply chain entity with respect to the at least one of the product or the service, one or more activities of the second supply entity within the supply chain, and a geographic location at which the second supply chain entity is operating. The operations further include determining, based on the obtained information, whether the first supply chain entity is authorized to add the at least one of the product or the service to the supply chain. The operations further include, responsive to determining that the first supply chain entity is not authorized to add the at least one of the product or the service to the supply chain, transmitting a notification to the client device indicating that the first supply chain entity is not authorized to add the at least one of the product or the service to the supply chain.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 depicts an illustrative computer system architecture, according to aspects of the present disclosure.

FIG. 2 is a flow diagram for an example method of assigning a unique identifier to a validated supply chain entity in an entity validation database, according to aspects of the present disclosure.

FIG. 3 depicts an example identifier registration engine, according to aspects of the present disclosure.

FIG. 4 depicts an example distributed ledger, according to aspects of the present disclosure.

FIG. 5 illustrates example entity data validated by an entity validation platform, according to aspects of the present disclosure.

FIG. 6 is a flow diagram for an example method of validating a supply chain entity for participation in a supply chain, according to aspects of the present disclosure.

FIG. 7 depicts an example identifier verification engine 180, according to aspects of the present disclosure.

FIG. 8 is a block diagram illustrating a computer system, according to aspects of the present disclosure.

### DETAILED DESCRIPTION OF EMBODIMENTS

Embodiments disclosed herein include methods and systems for supply chain entity validation. A supply chain can include multiple different types of entities that are responsible for performing particular tasks for products and/or services of the supply chain. For example, a design and/or development entity can design and/or develop a product to be introduced into a supply chain, a manufacturing entity can manufacture the products (as well as products associated with other entities), a transportation entity can transport products between other entities of the supply chain, and so forth. Some supply chains (e.g., global supply chains) can include a significant number of supply chain entities that may operate in different countries or jurisdictions. In some instances, each supply chain can transport a significant number of products into (e.g., thousands, hundreds of thousands, millions, etc.) and/or provide a significant number of services at a respective country or jurisdiction.

Supply chain authorities (e.g., customs agents, border patrol agents, etc.) can be responsible for monitoring products transported into a respective country or jurisdiction, as well as identifying and stopping counterfeit products (i.e., products created and/or shipped into the country or jurisdiction without license by an intellectual property owner associated with the product) or other unauthorized products or services from being distributed in the country or jurisdiction. For example, for a respective product transported into a particular jurisdiction, a supply chain authority can be responsible for identifying one or more supply chain entities associated with the respective product, identifying an owner of intellectual property (e.g., patents, copyrights, trademarks, etc.) associated with the respective product, determining whether the supply chain entity that is transporting the respective product is authorized by the intellectual property owner to transport the respective product into the particular jurisdiction, and, in some instances, determining whether the supply chain entity is operating in accordance with laws and regulations of the particular jurisdiction. If the supply chain entity is not authorized by the intellectual property owner to transport the respective product into the particular jurisdiction and/or the supply chain entity is not operating in accordance with the laws and regulations of the particular jurisdiction, the supply chain authority can remove the product from the supply chain and can prevent the product from being distributed within the jurisdiction (e.g., by seizing a shipment including the respective products transported into the jurisdiction).

Verifying that a respective supply chain entity is authorized to transport a respective product into a particular jurisdiction and/or whether the respective supply chain entity is operating in accordance with jurisdictional laws and regulations can take a significant amount of time and, in some instances, can consume a significant amount of computing system resources. For example, for a respective product, a supply chain authority may use a client device to access (e.g., via a network), multiple different databases to obtain information associated with the respective supply chain entity, information with other supply entities of the supply chain, information associated with an intellectual property owner of the respective products, and so forth. The supply chain authority may use the client device to cross-reference the obtained information with information provided by the respective supply chain authority to determine whether the supply chain entity is authorized to transport the respective product and/or operating in accordance with the jurisdictional laws and regulations. Obtaining and/or cross-referencing the information can take a significant amount of time (e.g., hours and in some instances days) and can consume a significant amount of computing system resources, such as processing cycles, memory space, etc., for computing systems supporting each of the multiple databases and/or the client device used to access the databases. Given the significant number of products being transported into the jurisdiction via a significant number of product supply chains, supply chain authorities may not be able to verify that each respective supply chain entity is operating in accordance with the above-described conditions. Accordingly, supply chain authorities may only be able to attempt verification for a small portion of products (in some instances as few of 1% or less of products) transported into the jurisdiction. Such systems enable malicious actors to transport counterfeit or otherwise unauthorized products into a jurisdiction without detection by supply chain authorities.

Embodiments of the present disclosure are directed to methods and systems for supply chain entity validation. An entity validation platform can maintain a database of unique identifiers for entities participating in one or more supply chains. Each unique identifier of the database can be used to validate an identity associated with a respective entity participating in the one or more supply chains. When a supply chain entity requests assignment of a unique identifier the entity validation platform can validate information (e.g., a name associated with the entity, one or more types of products associated with the entity, an entity ownership structure of the supply chain entity, intellectual property ownership associated with the supply chain entity with respect to the one or more types of products, activities of the entity within the one or more product supply chains, a geographic location at which the supply chain entity is operating, etc.) before the unique identifier is added to the database, in some embodiments. In some embodiments, the database can also include an indication of a relationship between the supply chain entity requesting the unique identifier and other entities of the supply chain. The platform can determine, based on the validated information, whether the requesting entity is authorized to transport one or more types of products and/or perform one or more types of services in to a jurisdiction, and/or whether the entity operates in accordance with laws and regulations of the jurisdiction. When an entity transports products into a jurisdiction, a supply chain authority can use a client device to access the database to verify that the entity is authorized (e.g., by the intellectual property owner of the products) to transport the products into the jurisdiction and/or whether the entity operates in accordance with laws and regulations of the jurisdiction. The supply chain authority is also able to identify a relationship of the supply chain entity to other entities of the supply chain and, in some instances, a chain of possession of the products by the entities of the supply chain.

Embodiments of the present disclosure provide techniques for validating information associated with supply chain entities that are associated with products transported into a jurisdiction. The entity validation platform can validate information provided by a supply chain entity before the entity transports products into and/or performs services within the jurisdiction. In some embodiments, the validation can occur at any time prior to, while, or after the products and/or services are transported into the jurisdiction. The provided information can be validated based on information residing on multiple different sources (e.g., databases, etc.), which can be hosted by multiple different computing systems. Once the provided information is validated, a unique identifier for the entity can be added to the entity validation database maintained by the entity validation platform, which can be referenced by a supply chain authority to determine whether the entity, or another entity attempting to transport products associated with the entity, is authorized to transport the products and/or whether the entity operates in accordance with jurisdiction laws and regulations. By providing the entity validation database and corresponding validation techniques, supply chain authorities are able to validate information associated with a supply chain entity attempting to transport products into a jurisdiction by accessing a single source (i.e., the entity validation database) instead of multiple sources. Accordingly, a fewer amount of computing resources (e.g., processing cycles, memory space, etc.) associated with computing systems that host such sources are consumed. Additionally, supply chain authorities can attempt to verify information for a larger portion of entities transporting products in the jurisdiction, which can significantly reduce the number of malicious actors that transport counterfeit or otherwise unauthorized products into a jurisdiction.

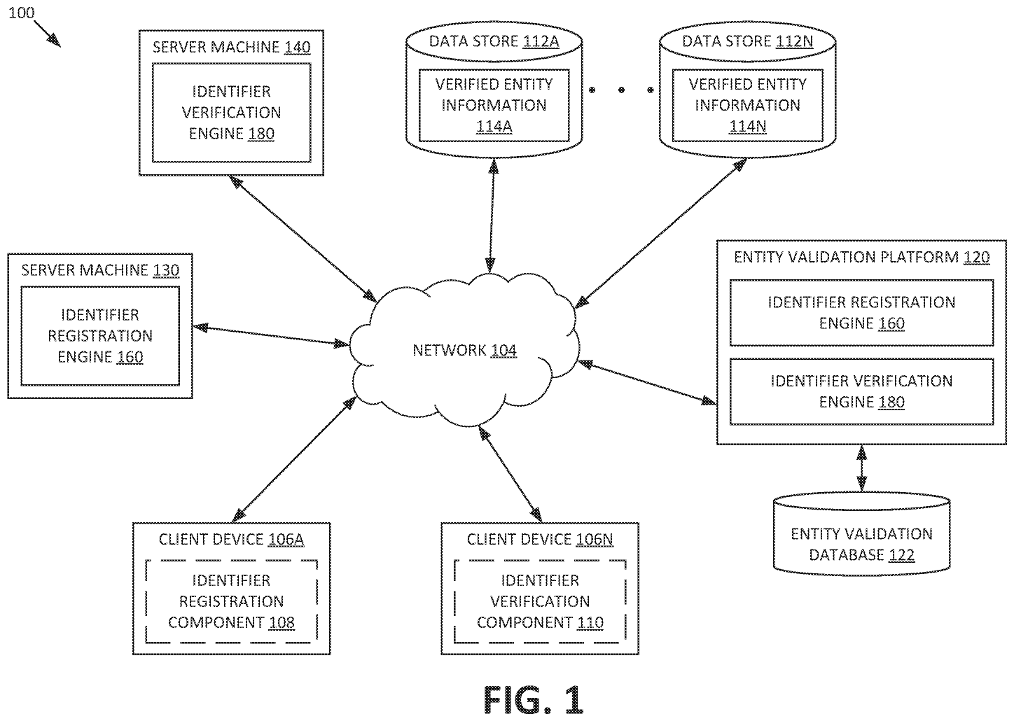

FIG. 1 depicts an illustrative computer system architecture 100, according to aspects of the present disclosure. Computer system architecture 100 (also referred to herein as computer system 100) includes one or more client devices 106, an entity validation platform 120, one or more data stores 112, and one or more server machines, (e.g., server machine 130, server machine 140, etc.). In some embodiments, client device(s) 106, entity validation platform 120, data store(s) 112, server machine 130 and/or server machine 140 can be connected via a network 104. In some embodiments, network 104 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Entity validation platform 120 can maintain a database of unique identifiers for entities participating in one or more product supply chains (i.e., entity validation database 122). Each unique identifier of entity validation database 122 can correspond to a respective entity (e.g., a design and/or development entity, a manufacturing entity, a transportation entity, etc.) participating in one or more product supply chains. A unique identifier can include a string of alphanumeric characters, symbols, etc. In some embodiments, a unique identifier can be a decentralized identifier. In some embodiments, entity validation database 122 can be a distributed ledger. A distributed ledger can be or otherwise include a blockchain, in some embodiments. Each entry of the entity validation database 122 can correspond to a block of the blockchain. In some embodiments, the blockchain can be a public blockchain (e.g., a blockchain that is accessible any user and/or entity) and/or a private blockchain (e.g., a blockchain that is accessible to specific users and/or entities based on authorizations provided by an entity that owns or otherwise controls the blockchain). In other or similar embodiments, the blockchain can be a permissioned blockchain which can allow multiple users or entities to access the blockchain. It should be noted that although some embodiments describe database 122 as a distributed ledger or a blockchain, database 122 can be any type of database structure, in accordance with embodiments of the present disclosure. For example, database 122 can be a relational database structure (e.g., a collection of data items with pre-defined relationships between them) a non-relational database structure, a linked data model, and so forth.

Entity validation platform 120 can include an identifier registration engine 160 and/or an identifier verification engine 180. An engine can include one or more hardware or software components that perform one or more operations with respect to entity validation platform 120. Identifier registration engine 160 can be configured to facilitate registration and assignment of a unique identifier to a supply chain entity. In some embodiments, identifier registration engine 160 can validate information associated with a supply chain entity that is requesting assignment of a unique identifier. For example, identifier registration component 160 can receive a request from a supply chain entity (e.g., via a client device, such as client device 106A) for assignment of a unique identifier by entity validation platform 120. Identifier registration engine 160 can obtain information associated with the requesting entity (e.g., a name associated with the entity, one or more types of products associated with the entity, etc.) and can validate the obtained information in view of verified information associated with the entity (e.g., verified entity information 114). As illustrated in FIG. 1, verified entity information 114 can be stored in one or more data stores 112 connected to entity validation platform 120. In some embodiments, data stores 112 can include data that is maintained and/or controlled by third-party independent entities. For example, a first data store 112A can be a data store maintained by a government entity (e.g., a state government). The verified entity information 114A stored in first data store 112A can include information associated with each entity incorporated within a jurisdiction (e.g., a state) controlled by the government entity. In another example, a second data store 112N can be a data store maintained by another government entity (e.g., a federal government). The verified entity information 114A stored in second data store 114N can include information associated with intellectual property rights (e.g., patent rights, trademark rights, etc.) allocated to various supply chain entities (e.g., design and/or development entities, etc.). The verified entity information 114 can include any type of information associated with a supply chain entity (or an entity requesting an identifier on behalf of the supply chain entity), which can include information relating to a role or function of the supply chain entity, information relating to a location at which the supply chain entity operates, beneficiary ownership information associated with the supply chain entity, one or more verified identifiers issued to the supply chain entity (e.g., a legal entity identifier (LEI), a data universal numbering system (DUNS) identifier, etc.), and so forth. Identifier registration component 160 can validate the obtained information for a requesting entity based on the verified entity information 114 included in the one or more data stores 112 by confirming whether the obtained information corresponds to the verified entity information 114. Identifier registration component 160 can assign the requesting entity a unique identifier responsive to validating the obtained information.

Identifier verification engine 180 can be configured to facilitate verification of information associated with a supply chain entity and/or products being transported into a jurisdiction. Identifier verification engine 180 may verify the associated information based on the information included in entity validation database 122. In some embodiments, a supply chain authority (e.g., a customs and border patrol agent, etc.) can provide a request (e.g., via a client device 106N) to validate information associated with a supply chain entity attempting to transport products into a jurisdiction. In other or similar embodiments, the request can be provided by the supply chain entity or another supply chain entity of the supply chain. The request can include information about the supply chain entity and/or the products being transported into the jurisdiction. Identifier verification engine 180 can receive the request and can validate whether the supply chain entity is authorized to transport the products into the jurisdiction and/or whether the entity operates in accordance with laws and regulations of the jurisdiction based on the information included in entity validation database 122. For example, identifier verification engine 180 can identify a unique identifier associated with the supply chain entity and/or the products based on information provided by the supply chain entity. Identifier verification engine 180 can identify one or more entries of the database 122 that correspond to the unique identifier and can obtain information associated with the entity that is assigned the unique identifier from the one or more identified entries. Identifier verification component 180 can compare the information associated with the supply chain entity and/or the products with the information included in the entity validation database 122 to determine whether the supply chain entity is authorized to transport the products into the jurisdiction and/or operates according to the jurisdiction laws and/or regulations. Identifier verification engine 180 can transmit an indication of the determination to client device 106N and client device 106N can provide an indication to the supply chain authority (e.g., via a graphical user interface (GUI) of the client device 106N) indicating whether the entity has such authority and/or is operating according to the jurisdiction laws and/or regulations. The supply chain authority can decide whether to remove the products from the supply chain based on the provided indication.

As illustrated in FIG. 1, identifier registration engine 160 and/or identifier verification engine 180 can be maintained or otherwise managed by entity validation platform 120. In such embodiments, identifier registration engine 160 and/or identifier verification engine 180 may reside on one or more computing systems (e.g., server machines) associated with platform 120. In other or similar embodiments, identifier registration engine 160 and/or identifier verification engine 180 can reside at one or more server machines (e.g., server machine 130, 140) connected to platform 120 (e.g., via network 104). For purposes of example and illustration only, identifier registration engine 160 may be described to reside at server machine 130 and identifier verification engine 180 may be described to reside at server machine 140. It should be noted, however, that identifier registration engine 160 and/or identifier verification engine 180 may reside at any server machine or computing system of or otherwise connected to system 100. It should also be noted that, in some embodiments, identifier registration engine 160 and/or identifier verification engine 180 may reside at the same server machine (e.g., server machine 130, server machine 140, etc.).

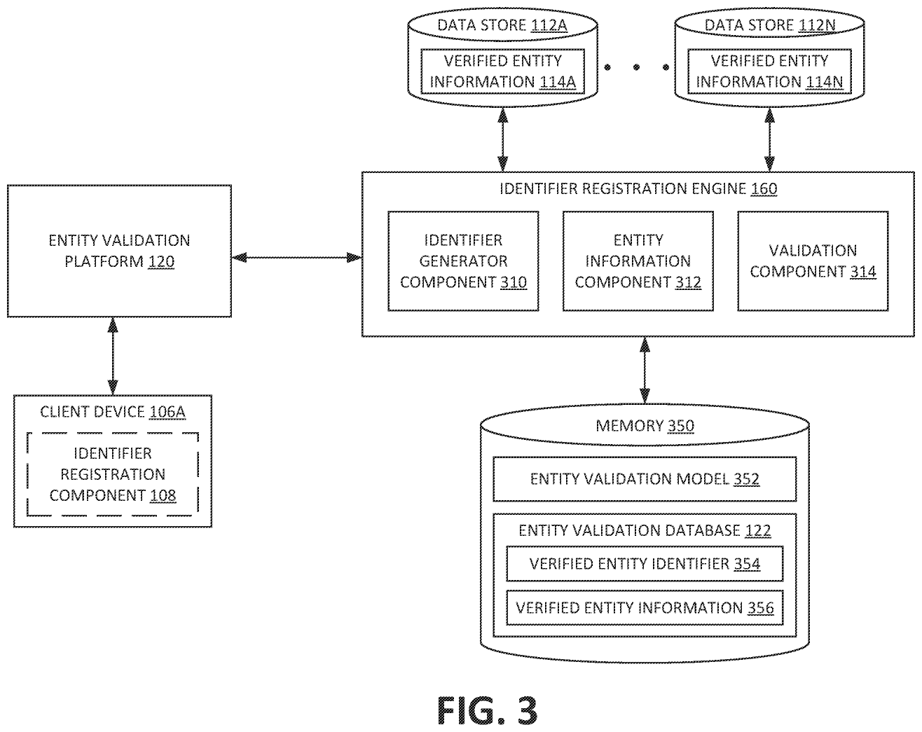

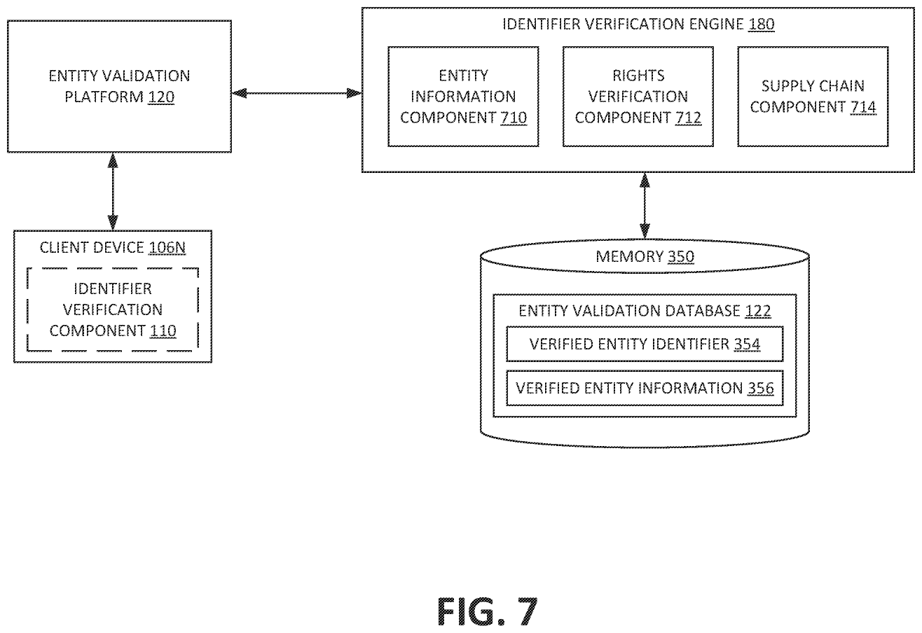

In some embodiments, one or more client devices 106 can be connected to platform 120 (e.g., via network 104). A client device can include computing devices such as personal computers (PCs), laptops, mobile phones, smart phones, tablet computers, netbook computers, network-connected televisions, etc. In some examples, a client device can also be referred to as a “user device.” In some embodiments, platform 120 can provide an identifier registration component 108 and/or an identifier verification component 110 to client devices 106 (e.g., via network 104). Identifier registration component 108 can enable a user of a client device 106 (e.g., a supply chain entity) to request assignment of an identifier by entity validation platform 120, in some embodiments. Identifier verification component 110 can enable a user of a client device 106 (e.g., a supply chain authority, a supply chain entity, etc.) to request verification of whether a supply chain entity is authorized to add and/or access a product or a service of a particular supply chain (e.g., in view of data of entity validation database 122). Further details regarding identifier registration component 108 and identifier verification component 110 are provided with respect to FIGS. 3 and 7. For purposes of example and illustration only, identifier registration component 108 may be described as residing at client device 106A and identifier verification component 110 may be described as residing at client device 106B. It should be noted, however, that identifier registration component 108 and/or identifier verification component 110 can reside at any client device connected to entity validation platform 120 (e.g., via network 104 or another network), in accordance with embodiments of the present disclosure. It should also be noted that identifier registration component 108 and identifier verification component 110 can reside at the same client device (e.g., client device 106A, client device 106 N, etc.).

In some implementations, platform 120 and/or server machines 130, 140 may operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. In some implementations, the functions of platform 120, and/or server machines 130, 140 may be provided by a more than one machine. For example, in some implementations, the functions of identifier registration engine 160 and/or identifier verification engine 180 may be provided by two or more separate server machines. Platform 120 and/or server machines 130, 140 may also include a website (e.g., a webpage) or application back-end software that may be used to enable a user to data of entity validation database 122, as described herein.

In general, functions described in implementations as being performed by platform 120 can also be performed on the client devices 106 in other implementations, if appropriate. In addition, the functionality attributed to a particular component can be performed by different or multiple components operating together. Content sharing platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In situations in which the systems discussed here collect personal information about users, or can make use of personal information, the users can be provided with an opportunity to control whether platform 120 collects user information. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120.

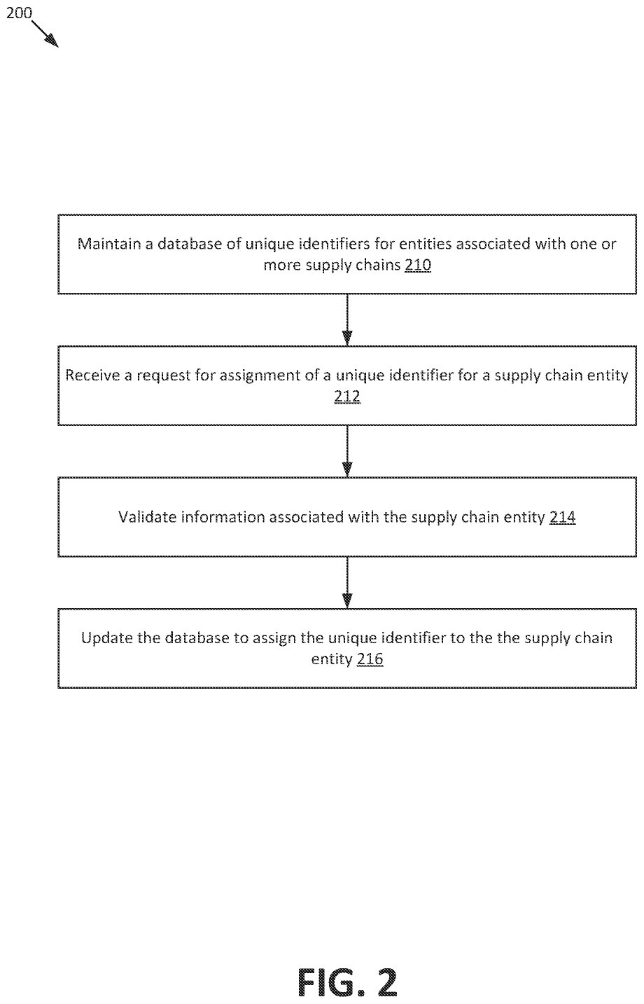

FIG. 2 is a flow diagram for an example method 200 of assigning a unique identifier to a verified supply chain entity in an entity verification database, according to aspects of the present disclosure. Method 200 may be performed by processing logic that may include hardware (circuitry, dedicated logic, etc.), software (e.g., instructions run on a processing device), or a combination thereof. In some embodiments, some or all the operations of methods 200 may be performed by one or more components of system 100 of FIG. 1. In some embodiments, some or all operations of methods 200 may be performed by identifier registration engine 160 of FIG. 1 and FIG. 3, as described herein.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 210, processing logic (e.g., identifier registration engine 160) can maintain a database of unique identifiers for entities associated with one or more supply chains. An entity can be associated with a supply chain if the entity is a participant of the supply chain, is going to participate in a supply chain, and/or has previously participated in a supply chain. In some embodiments, the database can correspond to entity validation database 122. As described above, entity validation database 122 can include information associated with each entity that is registered with entity validation platform 120 (e.g., each entity that is assigned a unique identifier). Such entity information can include a name associated with a respective entity, contact information associated with the respective entity (e.g., a phone number, a mailing address, an electronic mailing address, a website address, etc.) an indication of one or more products associated with the respective entity, an entity ownership structure associated with the entity, intellectual property ownership of the entity with respect to the one or more products, one or more activities of the entity within one or more product supply chains, and a geographic location at which the supply chain entity is operating, etc. The information that is included for each entity in the entity validation database 122 can be validated in view of verified entity information (e.g., verified entity information 114), as described herein.

At block 212, processing logic can receive a request for assignment of a unique identifier for a supply chain entity. In some embodiments, processing logic (e.g., identifier registration component 160) can receive the request in response to the supply chain entity (also referred to as a requesting entity herein) interacting with a client device (e.g., client device 106A) connected to entity validation platform 120. The request can include at least an indication of a name associated with the supply chain entity and an indication of one or more types of products and/or services associated with the supply chain entity. In some embodiments, the request can additionally include additional information, including one or more of an entity ownership structure associated with the entity, an intellectual property ownership status of the entity with respect to the one or more products, one or more activities of the entity within one or more product supply chains, and/or a geographic location at which the supply chain entity is operating, and so forth.

FIG. 3 depicts an example identifier registration engine 160, in accordance with embodiments of the present disclosure. As described above, identifier registration engine 160 can be managed by or otherwise accessible to entity validation platform 120 (e.g., via network 104). In some embodiments, identifier registration engine 160 can include an identifier generator component 310, an entity information component 312, and/or a validation component 314. Identifier registration engine 160 can manage or otherwise access entity validation database 122. As illustrated in FIG. 3, entity validation database 122 can reside at memory 350. Memory 350 can include any memory of or accessible to system 100.

As described above, identifier registration engine 160 can receive a request for assignment of a unique identifier for a supply chain entity. In some embodiments, a user associated with client device 106A can request assignment of the unique identifier via a graphical user interface (GUI) provided by identifier registration component 108 at client device 106A. As described above, identifier registration component 108 can be provided to client device 106A by entity validation platform 120 and/or by identifier registration engine 160. The request for the assignment for the unique identifier can include an indication of the name of the supply chain entity and an indication of the one or more types of products and/or services associated with the supply chain entity, in some embodiments. In additional or alternative embodiments, the request can include the additional information (e.g., the entity ownership structure, the intellectual property ownership status, etc.). In some embodiments, the user associated with client device 106a can be the supply chain entity for which the unique identifier is requested. In other or similar embodiments, the user can be another supply chain entity associated with the supply chain entity for which the unique identifier is requested. In yet other or similar embodiments, the user can be a supply chain authority (e.g., a CBP agent, etc.) requesting the unique identifier for a supply chain entity.

In response to receiving the request via the GUI of client device 106A, identifier registration component 108 can forward the request to entity validation platform 120. In some embodiments, entity validation platform 120 may reside at one or more server machines at different locations. In such embodiments, identifier registration component 108 can forward the request to a server machine hosting entity validation platform 120 that satisfies one or more conditions (e.g., is the closest machine located to the client device 106A, is a machine that has bandwidth to process the request, etc.). The forwarded request can include the information provided to client device 106A by the user (e.g., the name of the supply chain entity, the indication of the one or more types of products and/or services, the additional information, etc.).

In response to receiving the forwarded request, entity validation platform 120 can provide the information of the request to identifier registration engine 160. In some embodiments, identifier generator component 310 can generate a unique identifier for the supply chain entity in response to the request being received (e.g., and prior to the information provided by the supply chain entity being validated). In some embodiments, the unique identifier can be a string of alphanumeric characters and/or symbols. Identifier generator component 310 can add the generated unique identifier to entity validation database 122 before the information associated with the supply chain entity is validated, in some embodiments. In such embodiments, identifier generator component 310 can add a notification (e.g., a flag, etc.) indicating that the information associated with the supply chain entity has not been validated.

Referring back to FIG. 2, at block 214, processing logic can validate information associated with the supply chain entity. In some embodiments, processing logic (e.g., identifier registration component 160) can validate an entity ownership structure associated with the entity, intellectual property ownership of the entity with respect to the one or more products, one or more activities of the entity within one or more product supply chains, and/or a geographic location at which the supply chain entity is operating associated with the entity. In some embodiments, identifier registration component 160 can validate the information associated with the supply chain entity based on verified entity information 114 maintained in data stores 112 maintained and/or controlled by third party independent entities. In some embodiments, entity information component 120 can identify verified entity information 114 corresponding with the supply chain entity and/or one or more products or services of the request from one or more of data stores 112 and compare the identified verified entity information 114 with the information of the request from client device 106A. In an illustrative example, the request associated with the supply chain entity can indicate that a name of the supply chain entity is “Acme, Inc.” The request can further include an indication of one or more products or services associated with “Acme, Inc.” Entity information component 312 can parse one or more databases at data stores 112A-112N to identify verified information 114 associated with “Acme, Inc.” and/or products or services associated with “Acme, Inc.”

Validation component 314 can determine whether the information provided with the request corresponds to the verified information 114 identified by entity information component 312. In accordance with the previous illustrative example, entity information component 312 can identify verified entity information 114 associated with “Acme, Inc.” The verified information 114 may not indicate that “Acme, Inc.” is associated with the products or services indicated by the request. Accordingly, validation component 314 can determine that the information provided with the request does not correspond to the verified information 114 identified by entity information component 312. In such example or embodiment, identifier registration engine 160 can transmit a notification to client device 106A requesting additional information or documentation to prove that “Acme, Inc.” is associated with the product or services indicated by the request.

In some embodiments, entity information component 312 may identify additional information associated with the supply chain entity at data stores 112 (e.g., that is not included in the request from client device 106A. In another illustrative example, the request from client device 106A can indicate that the name of the supply chain entity is “Acme, Inc.,” one or more products or services associated with “Acme, Inc.” and an indication of a corporate structure associated with “Acme, Inc.” Entity information component 312 can parse one or more databases of data stores 112 and can identify a patent or trademark that is assigned to “Acme, Inc.” The patent or trademark can relate to the products or services associated with “Acme, Inc.” Validation component 314 can determine that “Acme, Inc.” is associated with the product and/or service and owns intellectual property rights for the product and/or service based on the information of the request and the validated entity information 114 obtained from the databases.

In some embodiments, validation component 314 can determine that the information of the request provided by client device 106A is valid if the information corresponds to verified entity information 114 data stores 112 in view of one or more rules or conditions associated with the geographic location of the supply chain the supply chain is to enter. In some embodiments, the rules or conditions associated with the geographic location can correspond to jurisdictional laws, regulations, etc. associated with the supply chain in the geographic location. In an illustrative example, a law or regulation of a geographic location can provide that products or services having a particular mark are not to be imported into the geographic location by an entity that does not own or have license to the mark (e.g., if the mark is registered for trademark protection). In response to determining, based on the information of the request and the verified entity information 114, that the supply chain entity is associated with a product or service indicated by the request and owns or has license to the mark, validation component 314 can determine that the supply chain entity is authorized to import the product or service having the mark into the geographic location and therefore the supply chain entity is a validated or verified entity. In response to determining that the supply chain entity is not associated with a product or service and/or does not own or have license to the mark associated with the product or service, validation component 314 can determine that the supply chain entity is not authorized to import the product or service having the mark into the geographic location and therefore the supply chain entity is not a validated or verified entity. Validation component 314 can update entity validation database 122 to include an indication of whether the supply chain entity is a verified or validated entity, in accordance with embodiments described herein.

In additional or alternative embodiments, identifier registration component 160 can validate the information based on information already included in the entity validation database 122 (e.g., information associated with the entity and/or the products that is provided by another supply chain entity, information associated with another supply chain entity, etc.). In an illustrative example, the request from client device 106A can indicate that a name associated with the supply chain entity is “Acme, Inc.” Entity information component 312 can parse entity validation database 122 to identify an entry associated with “Acme, Inc.,” in some embodiments. In response to entity information component 312 identifying an entry associated with “Acme, Inc.,” validation component 314 can determine whether the verified entity information 356 of the entry corresponds to the information of the request. If the information corresponds to the information of the request, validation component 314 can determine that “Acme, Inc.” is a valid or verified entity, in some instances. If the information does not correspond to the information of the request, validation component 314 can determine that “Acme, Inc.” is not a valid or verified entity. In such instances, validation component 314 can transmit a request to client device 106A for additional information, as described above.

In yet other or similar embodiments, identifier registration component 160 can use one or more machine learning models (e.g., entity validation model 352) to validate the information associated with the supply chain entity. For example, identifier registration component 160 can obtain information associated with the requesting entity and/or the one or more products from data stores 112, as described above. Identifier registration component 160 can provide the obtained information, as well as the information provided with the request, as input to a machine learning model 352. In some embodiments, entity validation model 352 may be trained to determine whether information provided by the request from client device 106A corresponds to verified information obtained from third party independent sources (e.g., data stores 112) and/or information already included in entity validation database 122. The model 352 may be further or alternatively trained to determine whether the supply chain entity is a fraudulent entity and/or has engaged in dishonorable activity. In additional or alternative embodiments, the model 352 may be further or alternatively trained to determine whether information provided to the platform 120 by the supply chain entity (or by another requesting entity) is fraudulent information. In some embodiments, entity validation model 352 can be trained based on historical data indicating a historical supply chain activity by one or more additional supply chain entities and one or more supply chain conditions satisfied or violated by the historical supply chain activity by the one or more additional supply chain entities. The one or more supply chain conditions can include one or more jurisdictional laws or regulations of a geographic location for which the historical supply chain activity occurred, in some embodiments. In other or similar embodiments, the one or more supply chain conditions can include or be otherwise related to a lien or judgment against the historical supply chain entity, pricing practices of the historical supply chain entity, a payment history of the historical supply chain entity, an organizational governance of the supply chain entity, and so forth.

In an illustrative example, entity validation model 352 can be trained based on a training set that includes a set of training inputs and a set of target outputs. The set of training inputs can include an indication of a historical supply chain activity by the one or more supply chain entities. The historical supply chain activity can be represented as or can include information associated with transactions between two or more supply chain entities, in some embodiments. The historical supply chain activity information can be extracted from one or more historical documents or files provided to the platform 120 by the supply chain entities (e.g., via a client device 106) or otherwise obtained by the platform 120. The set of target outputs can indicate a supply chain condition and whether the historical supply chain activity violated or satisfied the supply chain condition. The training data can include a mapping between a respective training input of the set of training inputs and a corresponding target output of the set of target outputs. Machine learning model 352 can be a neural network, a large language model, a transformer model, a reinforcement learning model, an adversarial machine learning model, and so forth. It should be noted that other types of artificial intelligence or other architectures can be applied to embodiments of the disclosure.

Validation component 314 can obtain one or more outputs from the model 352 and can extract, from the one or more outputs, entity validation data. The entity validation data can include, in some embodiments, a score or a rating that indicates a degree of correspondence between the information included in the request and the obtained information and/or information already included in entity validation database 122. Validation component 314 can determine that the information provided by the requesting entity is valid by determining that the score or rating satisfies a score or rating criterion (e.g., exceeds a score or rating threshold, etc.). In other or similar embodiments, the entity validation data can indicate a level of confidence that the supply chain entity is a fraudulent supply chain entity or that the entity is engaged in one or more dishonorable practices. Validation component 314 can determine whether the supply chain entity is validated or verified by determining whether the level of confidence of the one or more outputs satisfies one or more confidence criteria (e.g., exceeds a level of confidence threshold). It should be noted that validation component 314 can use additional or alternative techniques to validate the information provided by the requesting entity.

As indicated above, validation component 314 may not validate the information provided by the requesting entity. For example, validation component 314 can determine that one or more pieces of information provided by the requesting entity do not correspond to verified entity information 114 of data store(s) 112. In some embodiments, validation component 314 can provide a notification to client device 106A indicating the piece of information that could not be validated. A user of client device 106A can provide additional and or supplemental information based on the notification (e.g., via the GUI of identifier registration component 108).

Referring back to FIG. 2, at block 216, processing logic (e.g., identifier registration component 160) can update the database to include the unique identifier for the supply chain entity. In some embodiments, identifier generator component 310 can update the database 122 by generating a unique identifier for the entity (e.g., via a random number generator, etc.) and adding an entry to the database that indicates the generated unique identifier (e.g., verified entity identifier 354). In some embodiments, identifier generator component 310 can generate the unique identifier before the information is validated, as described above, and can add the unique identifier to an entry of database 122 responsive to validating the information. In some embodiments, identifier registration component 160 can provide an indication of the unique identifier to client device 106A. Identifier registration component 160 can, in some embodiments, add the validated information associated with the supply chain entity to the entry associated with the unique identifier (e.g., as verified entity information 356). In some embodiments, identifier registration component 160 can add information associated with the requesting entity that has not been validated to database 122. In such embodiments, identifier registration component 160 can include with the information an indication that the information is not validated. Such information can be used by identifier registration component 160 to validate information associated with additional requesting entities, in some embodiments.

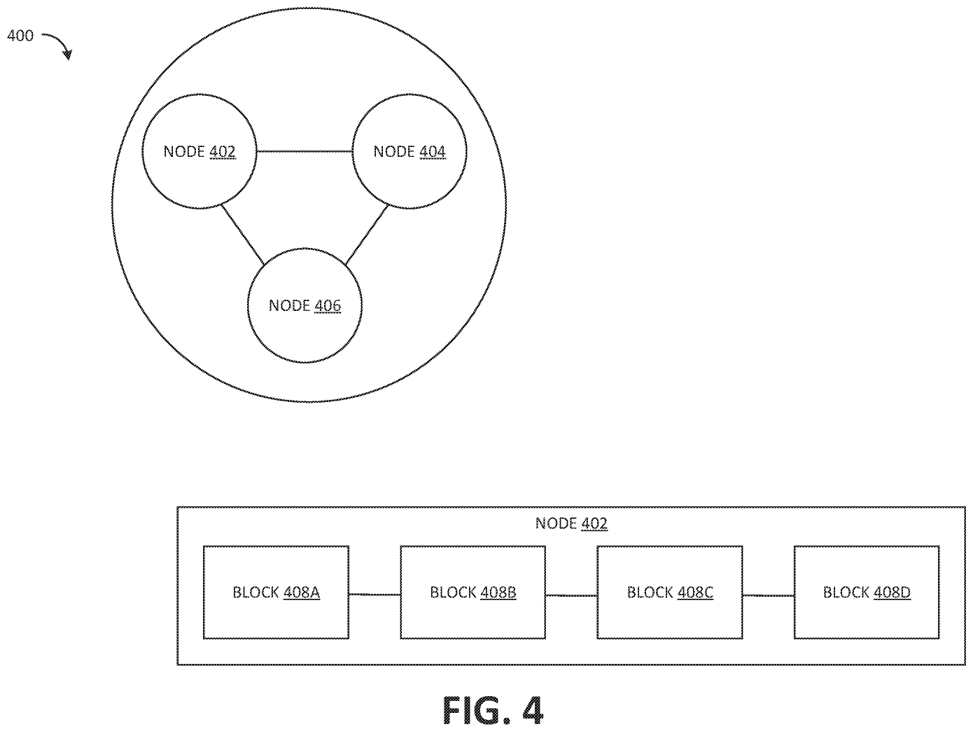

As indicated above, in some embodiments, database 122 can correspond to a distributed ledger network, such as a blockchain network. FIG. 4 depicts an example distributed ledger network 400, in accordance with embodiments of the present disclosure. In some embodiments, distributed ledger network 400 can include one or more nodes (e.g., node 402, node 404, node 406) that maintain one or more portions of a distributed ledger. A distributed ledger 400 can be a blockchain, in some embodiments. A blockchain is a type of distributed ledger that is used, for example, in a Bitcoin crypto-currency system. The blockchain is a data structure including a complete history of each block 408 in the distributed ledger network 400 from the first block (e.g., block 408A) to the most recently added block (e.g., block 408D). Each node of the distributed ledger network 400 can maintain a copy of all or a portion of the distributed ledger in storage (e.g., on disk or in RAM) that is local to the node. For example, each node 402, 404, and/or 406 can receive a copy of the distributed ledger upon joining the network. In accordance with embodiments described herein, nodes 402, 404, and/or 406 can correspond to one or more blockchain clients. In some embodiments, distributed ledger can be a public ledger that is maintained by distinct individual computer systems each operated by different entities that maintain a single blockchain. In additional or alternative embodiments, the distributed ledger can be maintained by one or more individual computing system that are operated by a single entity (e.g., a private or a closed system).

Nodes 402, 404, and/or 406 can sequentially record data into the distributed ledger of distributed ledger network 400 as blocks of data. For example, each of nodes 402, 404, and/or 406 can be operated to “process” blocks 408 (e.g., blocks 408A, 408B, 408C, 408D) of the distributed ledger by validating data associated with each block 408. In some embodiments, only one node receives data that has been broadcasted over a network (e.g., by entity validation platform 120). Once the node receives the data, it can propagate the data to other participating nodes of the distributed ledger network 400. The other participating nodes can add the data to their copy of the distributed ledger.

Nodes 402, 404, and/or 406 can validate a new block that is added to the distributed ledger network 400 by applying an operation to data of the block. The operation can involve solving a computationally difficult problem that can be verified easily (e.g., using minimal computing resources). In some embodiments, the operation can be a hash operation. In an illustrative example, each node of distributed ledger network 400 can execute instructions (e.g., via one or more processing devices of a local computing system of the node) to attempt to compute a hash value for a respective block 408 of the node using a cryptographic hash function (e.g., a secure hash algorithm (SHA)-256 function, etc.). An input to the hash function can include data associated with the block 408, in some embodiments and an output of the hash function can include hash value that represents the data of the block 408. Nodes 402, 404, and/or 406 can build blocks 408 that include a reference (e.g., a data pointer) to the hash value of the previously block 408 of the distributed ledger. As such, blocks 408 of the distributed ledger are explicitly ordered by reference to the previous blocks' hash value, which reflects the content of that previous block. In an illustrative example, block 408B is explicitly ordered by reference to the hash value of block 408A, block 408C is explicitly ordered by reference to the hash value of block 408B, block 408D is explicitly ordered by reference to the hash value of block 408C, and so forth.

It should be noted that although embodiments of the present disclosure describe distributed ledger network 400 as a blockchain, distributed ledger network 400 can include other types of distributed ledgers, in accordance with embodiments of the present disclosure. It should be further noted that although FIG. 2 depicts three nodes (e.g., nodes 402, 404, and 406) of distributed ledger network 400, distributed ledger network 400 can include any number of nodes. In addition, although FIG. 2 depicts node 402 as including four blocks (e.g., blocks 408A, 408B, 408C, and 408D), nodes 402, 404, and/or 406 can include any number of blocks. Further, any embodiments described respect to node 402 above can be applied to any other node (e.g., node 404, 406, etc.) of distributed ledger network 400.

In such embodiments, identifier registration component 160 can update database 122 by appending the unique identifier associated with the requesting entity to a data block (e.g., block 408) of the blockchain (e.g., distributed ledger 400) and broadcasting the data block 408 to one or more blockchain nodes 402. In some embodiments, identifier registration component 160 can also append data indicating the validated entity ownership structure, the validated intellectual property ownership, the validated one or more activities of the supply chain entity, and/or the validated geographic location for the supply chain entity to the data block 408 of the blockchain.

In some additional or alternative embodiments, a request provided by client device 106A can include an indication of a relationship between the requesting entity and another entity of the supply chain. In one example, a requesting distribution and/or transportation entity may provide an indication of a relationship between the distribution and/or transportation entity and a design and/or development entity. Identifier registration component 160 can validate the indicated relationship between the entities in accordance with embodiments described above. In one illustrative example, a requesting entity that holds intellectual property rights to a product or design of a product (e.g., as validated by identifier registration component 160) can provide an indication of one or more entities of the supply chain that have a license from the requesting entity to manufacture and/or distribute such products or products having the same or a similar design. In another illustrative example, the requesting entity can provide an indication of one or more entities of the supply chain that do not have a license from the requesting entity to manufacture and/or distribute such products or products having the same or a similar design. The indicated relationship between the requesting entity and the one or more entities can indicate to a supply chain authority whether a respective supply chain participant has a license to transport products or products having the same or a similar design as the products validated for the requesting entity, in accordance with embodiments described below.

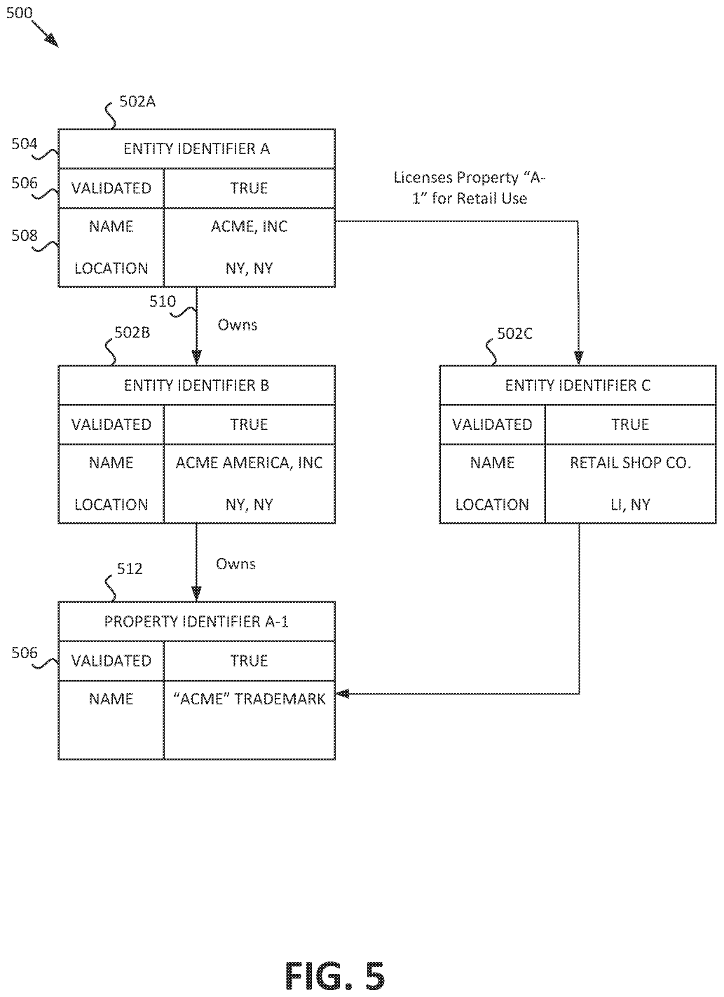

FIG. 5 illustrates example entity data 500, in accordance with embodiments of the present disclosure. In some embodiments, entity data 500 can include one or more unique identifiers associated with respective supply chain entities of one or more supply chains (e.g., generated by identifier generator component 310). Entity data 500 can additionally or alternatively include information associated with the respective supply chain entities (e.g., provided to platform 120 by client device 106A or obtained from data stores 112). In some embodiments, entity data 500 can include data or information that has been generated and/or validated for a supply chain entity (e.g., by verification component 314). One or more portions of entity data 500 can be included in entries 502 of entity validation database 122, in accordance with embodiments described herein.

As indicated above, an entry 502 of entity validation database 122 can indicate a unique identifier 504 assigned to a supply chain entity by identifier registration component 160. The unique identifier 504 can be assigned to the supply chain entity prior to or after information associated with the supply chain entity is validated. The entry can further include an indication of a validation status 506 of the information associated with the unique identity. The validation status 506 can indicate whether the information (or a portion of the information) associated with the supply chain entity has been validated or not. As illustrated in FIG. 5, entity data 500 can include entries 502 for supply chain entities having entity identifier “A,” entity identifier “B,” and entity identifier “C.” Prior to the information associated with the supply chain entities being validated by validation component 314, the validation status 506 of the information associated with the supply chain entities can be “FALSE.” Responsive to the information associated with the supply chain entities being validated by validation component 314, validation component 314 and/or identifier generator component 310 can update the validation status 506 of the respective entries 502 to be “TRUE.” By updating the validation status 506 of an entry 502 to be “TRUE,” a unique identifier 504 for a supply chain entity can be assigned to the supply chain entity for use by the entity validation platform 120 in verifying or validating supply chain entities participating in a respective supply chain.

In some embodiments, an entry 502 associated with a respective supply chain entity can include information 508 associated with the respective supply chain entity. The information 508 can be provided to entity validation platform 120 by a client device (e.g., client device 106A), obtained from data stores 112, and/or obtained based on other entries 502 of entity validation database 122, in some embodiments. As illustrated in FIG. 5, the information 508 can include at least a name associated with the supply chain entity and/or a location (e.g., a geographic location) where the supply chain entity operates. Information 508 can include additional or alternative information associated with the supply chain entity, in some embodiments.

In some embodiments, entity data 500 can include one or more mappings 510 that indicate a relationship between one or more supply chain entities having entries 502 in entity validation database 122. A mapping 510 can include a pointer (e.g., a link) between at least a first entry 502 associated with a first supply chain entity and a second entry 502 associated with a second supply chain entity. As illustrated in FIG. 5, entity data 500 can include a mapping 510 between entry 502A (e.g., associated with entity identifier “A”) and entry 502B (e.g., associated with entity identifier “B”). The mapping 510 between entry 502A and entry 502B can include an indication of a relationship status between the supply chain entities. A relationship status can include an ownership status, a licensee status, a litigation status, a status of an agreement between two or more entities, and so forth. As illustrated in FIG. 5, entity data 500 can indicate that the supply chain entity associated with entry 502A “owns” the supply chain entity associated with entry 502B.

In some embodiments, information 508 associated with a supply chain entity can include an indication of one or more products or services associated with the supply chain entity. The information 508 can additionally or alternatively include an indication of a property ownership status of the supply chain entity with respect to the one or more products or services. In additional or alternative embodiments, entity validation platform 120 can generate a unique identifier associated with the property that is owned, licensed, or otherwise associated with a respective supply chain entity. As illustrated in FIG. 5, entity data 500 can include an entry 512 corresponding to products or services having the “ACME” trademark. Products or services having the “ACME” trademark can be associated with property identifier “A-1,” which can be generated for the products or services before, during, or after generation of a unique identifier for a supply chain entity associated with the products or services.

In some embodiments, mappings 510 can additionally or alternatively indicate a property ownership status of one or more products or services by a supply chain entity. In an illustrative example, entity data 500 can include a mapping between entry 502B and entry 512, which indicates a property status (e.g., ownership) between products or services having the “ACME” trademark and the supply chain entity associated with entry 502B. Entry 512 can include a validation status 506 that indicates whether the property ownership status of a respective supply chain entity associated with an entry 502 mapped to the entry 512 is validated (e.g., by validation component 312). In response to validating the property ownership status of a respective supply chain entity associated with an entry 502 mapped to entry 512, identifier registration engine 160 can update the validation status 506 to be “TRUE.”

In another illustrative example, entity data 500 can further include a mapping 510 between the supply chain entity associated with entry 502A and the supply chain entity associated with entry 502C and that the supply chain entity associated with entry 502A has “licensed property ‘A-1’ for retail use.” In response to verifying the information for the supply chain entity associated with entries 502A and 502C, as described above, identifier registration engine 160 can update entity data 500 to include an additional mapping 510 between entry 502C and 512 which indicates the relationship and/or property ownership status (e.g., license) of the products and services associated with entry 512 and the supply chain entity (e.g., “Retail Shop Co.”) associated with entry 502C. It should be noted that although some examples or embodiments refer to an intellectual property ownership stake associated with one or more entities, such examples or embodiments can be applied to products or services for which intellectual property protection is not obtained or granted.

As described above, entries 502 of entity data 500 can be or otherwise correspond to entries of entity validation database 122, in accordance with previously described embodiments. In some embodiments, entries 502 of entity data can corresponds to data blocks 408 of nodes 402, 404, 406 of a distributed ledger network (e.g., a blockchain network). The mappings 510 and associated relationship status data and/or property ownership data can be included in a data block 408 associated with a respective entry and/or can be included in separate data blocks 408.

Referring back to FIG. 2, in some embodiments, the requesting entity can also provide data associated with the relationship. For example, the requesting entity may only grant a license for one or more other entities to a product or design of a product for a certain period of time. The requesting entity can provide an indication of the period of time that the one or more entities hold the license and identifier registration component 160 can update database 122 to include this information. When the period of time is expired (e.g., and the one or more entities no longer hold the license), identifier registration component 160 can update database 122 to indicate that the one or more entities no longer hold the license to the product or the design of the product.

In some embodiments, identifier registration component 160 can further validate the indicated relationship by transmitting a notification to client devices 106 associated with one or more entities of the relationship (e.g., the design and/or development entity of the previous example) and requesting that the one or more entities verify the relationship (e.g., via the client device 106 associated with the one or more entities, etc.). In some embodiments, a unique identifier has not been assigned to the one or more entities in the database 122. Identifier registration component 160 can generate a unique identifier for the one or more entities and add the generated unique identifier to the database 122, as described above. In some embodiments, identifier registration component 160 can include an indication that information associated with the one or more entities is not validated when the unique identifier is added to the database 122. The indication that the information is not validated can remain in the database 122 until the one or more entities provides information and/or identifier registration component 160 validates information for the database in view of verified entity information 144, as described above.

In some embodiments, an entity that is a party to a relationship with other entities (e.g., a distribution and/or transportation entity of the previous example, a design and/or development entity, etc.) can update database 122 based on changes to the relationship. In accordance with the previous example, after a relationship is validated between the requesting entity and the one or more entities of the supply chain, the requesting entity can provide an indication that the one or more entities no longer hold a license to the product or the design of the products owned by the requesting entity. Identifier registration component 160 can update database 122 to indicate the change to the relationship between the requesting entity and the one or more entities.

In some instances, a requesting entity can request assignment of a unique identifier for a supply chain entity that is already assigned a unique identifier. For example, a legitimate supply chain entity (e.g., an intellectual property rights holder, etc.) can be assigned a unique identifier, in accordance with embodiments described above. A malicious supply chain entity (e.g., an entity attempting to import counterfeit goods into a particular jurisdiction) can request a unique identifier for the supply chain entity by providing information associated with the legitimate supply chain entity (e.g., to impersonate the legitimate supply chain entity). Responsive to receiving the request, identifier registration component 160 can determine that a unique identifier has already been assigned to the supply chain entity associated with the provided information and the provided information has been verified in accordance with embodiments described above. Identifier registration component 160 can provide a notification to a client device 106 associated with the legitimate supply chain entity indicating that a malicious supply chain entity has attempted to impersonate the supply chain entity, in some embodiments. In additional or alternative embodiments, identifier registration component 160 can provide a notification to a client device 106 associated with a supply chain authority indicating the attempt by the malicious party to impersonate the legitimate supply chain entity. In some embodiments, identifier registration component 160 can provide additional information regarding the malicious supply chain entity to the client device 106 associated with the supply chain authority (e.g., an internet protocol address associated with the client device 106 that transmitted the request, a geographic location associated with the client device 106 that transmitted the request, etc.).

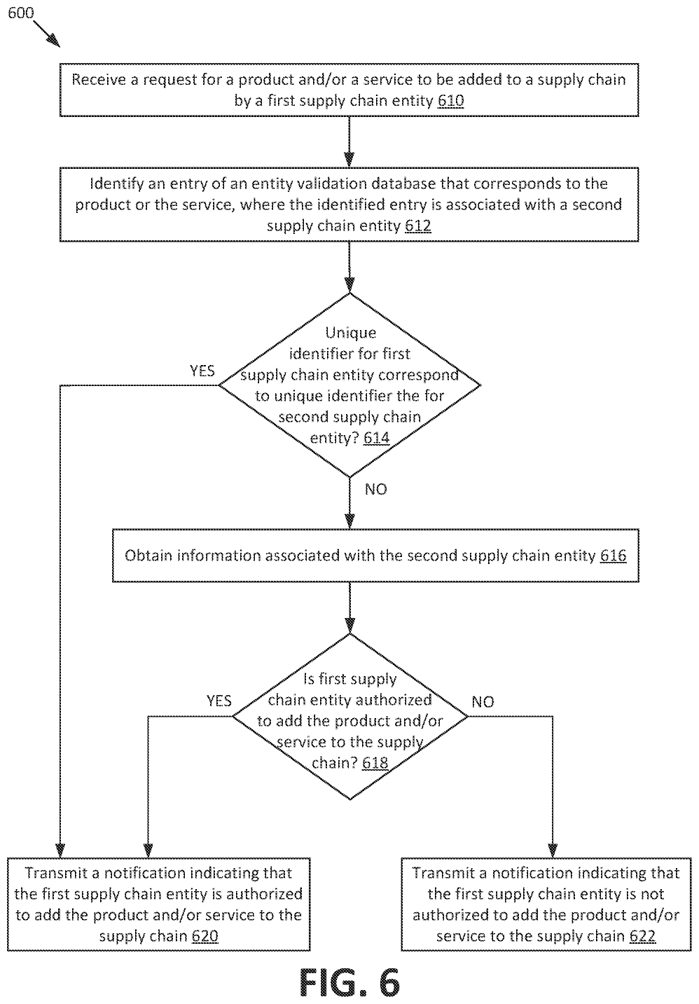

FIG. 6 is a flow diagram of an example method 600 of validating a supply chain entity for participation in a supply chain, according to aspects of the present disclosure. Method 600 may be performed by processing logic that may include hardware (circuitry, dedicated logic, etc.), software (e.g., instructions run on a processing device), or a combination thereof. In some embodiments, some or all the operations of methods 600 may be performed by one or more components of system 100 of FIG. 1. In some embodiments, some or all operations of methods 600 may be performed by identifier verification engine 180 of FIG. 1 and FIG. 7, as described herein.

For simplicity of explanation, the methods are depicted and described as a series of acts. However, acts in accordance with this disclosure can occur in various orders and/or concurrently, and with other acts not presented and described herein. Furthermore, not all illustrated acts can be performed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 610, processing logic (e.g., identifier verification engine 180) can receive a request for a product and/or a service to be added to a supply chain by a first supply chain entity. The request can be received from a client device connected to an entity validation platform. In some embodiments, the request can include a first unique identifier issued to the first supply chain entity by the entity validation platform.

FIG. 7 illustrates an example identifier verification engine 180, in accordance with embodiments of the present disclosure. As described above, identifier verification engine 180 can be included at or otherwise connected to entity validation platform 120 (e.g., via network 104). Identifier verification engine 180 can include one or more of an entity information component 710, a rights verification component 712, and/or a supply chain modifier component 714. In some embodiments, the request can be received by entity validation platform 120 from a client device 106N. Client device 106N can include an identifier verification component 110 that enables a user to request a product and/or a service to be added to a supply chain (e.g., via a GUI of identifier verification component 110). The user can be or correspond to the first supply chain entity and/or a supply chain authority, in some embodiments. In some embodiments, the user can provide an indication of the product and/or the service to be added to the supply chain via the GUI of identifier verification component 110 and a name associated with the first supply chain entity. In additional or alternative embodiments, the user can provide an indication of a unique identifier associated with the first supply chain entity. The unique identifier can be assigned to the first supply chain entity by identifier registration engine 160, in accordance with embodiments of the present disclosure. In response to receiving the request from the user associated with client device 106N, client device 106N can forward the request to entity validation platform 120 (e.g., via network 104). Entity validation platform 120 can provide the information of the request (e.g., the indication of the product or service to be added to the supply chain, the unique identifier associated with the first supply chain entity, etc.) to identifier verification engine 180.

Referring back to FIG. 6, at block 612, processing logic (e.g., entity information component 710) can identify an entry of an entity validation database that corresponds to the product or service. In some embodiments, entity information component 710 can parse through entity validation database 122 (e.g., at memory 350 or another memory) to identify an entry associated with the product or service. As described above, an entry (e.g., 502) associated with a supply chain entity can include verified entity information 356, which was verified or validated by validation component 314 of identifier registration engine 160. The verified entity information 356 can indicate one or more products or services associated with a supply chain entity assigned a verified entity identifier 354, in some embodiments. In such embodiments, entity information component 710 can parse through entity validation database 122 to identify an entry 502 including verified entity information 356 indicating the products or services. In other or similar embodiments, entity validation database 122 can include one or more entries (e.g., entries 512) associated with a particular product or service. In such embodiments, entity information component 710 can parse through entity validation database 122 to identify an entry 512 associated with the product and/or service of the request.

In some embodiments, entity information component 710 can determine that entity validation database 122 does not include an entry (e.g., entry 502, entry 512) associated with the product or service. In such embodiments, entity information component 710 can parse the entity validation database to determine whether entity validation database 122 includes an entry 502 associated with the first supply chain entity based on the unique identifier associated with the first supply chain entity or the name associated with the first supply chain entity. In response to identifying an entry 502 associated with the first supply chain entity, entity information component 710 can determine whether a product and/or service is associated with the first supply chain entity based on the verified entity information 356 of the identified entity. If a product and/or service is associated with the first supply chain entity, entity information component 710 can determine whether the product and/or or service is associated with the product and/or service of the request. If the product and/or or service is associated with the product and/or service of the request, entity information component 710 can determine that the entry associated with the first supply chain entity is associated with the product and/or service associated with the request.

If entity information component 710 is unable to identify an entity associated with the product and/or service of the request, identifier verification engine 180 may determine that the first supply chain entity is not associated with the product and/or service, in view of verified entity information 356 of the database, and therefore is not authorized to add the product and/or service to the supply chain. A notification indicating that the first supply chain entity is not authorized to add the product and/or service to the supply chain can be transmitted to client device 106N, in accordance with embodiments described herein.

As indicated above, in some embodiments, entity information component 710 can identify an entry (e.g., entry 502, entry 512, etc.) associated with the product and/or service of the request. If the entry corresponds to a supply chain entity (e.g., entry 502), entity information component 710 can extract a verified entity identifier 354 associated with the supply chain entity from the identified entry, in some embodiments. If the entry corresponds to a product and/or service (e.g., entry 512), entity information component 710 can identify one or more entries 502 that are mapped to the identified entry, as described with respect to FIG. 5, and can extract the verified entity identifier 354 associated with the supply chain entity of the identified one or more entries 502. In some embodiments, the verified entity identifier 354 can be associated with another supply chain entity (e.g., a second supply chain entity) that is different from the supply chain entity of the request.

Referring back to FIG. 6, at block 614, processing logic can determine whether the unique identifier for the first supply chain entity corresponds to the unique identifier for the second supply chain entity. In response to processing logic determining that the unique identifier for the first supply chain entity corresponds to the unique identifier for the second supply chain entity, method 600 can proceed to block 620. In response to processing logic determining that the identifier for the first supply chain entity does not correspond to the unique identifier for the second supply chain entity, method 600 can proceed to block 616.

As described above, in some embodiments, the request provided to entity validation platform 120 can include an indication of the verified entity identifier 354 for the first supply chain entity. In other or similar embodiments, the request may include an indication of a name associated with the first supply chain entity without including the verified entity identifier 354 for the first supply chain entity. In such embodiments, entity information component 710 can identify an entry associated with the first supply chain entity of entity validation database 122, as described herein, and can extract the verified entity identifier 354 from the identified entry. In response to determining that no entry of entity validation database 122 is associated with the first supply chain entity, entity information component 710 can transmit a request to identifier registration engine 180 to request generation of a unique entity identifier (e.g., via network 104), in accordance with embodiments described above. Identifier registration engine 180 can generate a unique entity identifier and provide the generated unique entity identifier to identifier verification engine 180. In some embodiments, the unique entity identifier may not be validated by validation component 314.

Rights verification component 712 can compare the verified entity identifier 354 for the first supply chain entity (e.g., or the non-validated unique entity identifier generated by identifier registration engine 180) to the verified entity identifier 354 for the second supply chain entity (e.g., associated with the identified entry of entity validation database 122). In response to determining that the verified entity identifier 354 (or the non-validated unique entity identifier) for the first supply chain entity corresponds to (e.g., matches or substantially matches) the verified entity identifier 354 for the second supply chain entity, rights verification component 712 can determine that the first supply chain entity is the same entity or otherwise related to the second supply chain entity and therefore is authorized to add the product and/or the service to the supply chain. Referring back to FIG. 6, at block 620, processing logic (e.g., identifier verification engine 180) can transmit a notification (e.g., to client device 160N) indicating that the first supply chain entity is authorized to add the product and/or service to the supply chain, as described herein.

As described above, in response to processing logic (e.g., identifier verification engine 180 and/or rights verification component 712) determining that the verified entity identifier 354 (or the non-validated unique entity identifier) for the first supply chain entity does not correspond to the verified entity identifier 354 for the second supply chain entity, method 600 can proceed to block 616. At block 616, processing logic can obtain information associated with the second supply chain entity. The information can correspond to an entity ownership structure associated with the second supply chain entity, an intellectual property ownership status of the products and/or services by the second supply chain entity, one or more activities of the second supply chain entity within the supply chain, and/or a geographic location at which the second supply chain entity is operating. In some embodiments, entity information component 710 can obtain the information associated with the second supply chain entity from an entry of entity validation database 122 associated with the second supply chain entity, another entry of entity validation database 122, and/or information from another database (e.g., a database of data stores 112).

At block 618, processing logic can determine, based on the obtained information at block 616, whether the first supply chain entity is authorized to add the at least one of the product or the service to the supply chain. In response to processing logic determining that the first supply chain entity is authorized to add the at least one of the product or the service to the supply chain, method 600 can proceed to block 620. In response to processing logic determining that the first supply chain entity is not authorized to add the at least one of the product or the service to the supply chain, method 600 can proceed to block 622.

As indicated, rights verification component 712 can determine whether the first supply chain entity is authorized to add the at least one of the product or the service to the supply chain based on the information associated with the second supply chain entity. In an illustrative example, the first supply chain entity can be associated with the name “Retail Shop Co.” and the second supply chain entity can be associated with the name “Acme, Inc.” and/or “Acme America, Inc.” Entity information component 710 can obtain verified entity information 356 associated with the supply chain entity, as described above. The obtained verified entity information 356 can include or otherwise correspond to entity data 500 of FIG. 5. Rights verification component 712 can determine a property ownership status of the products and/or services of the request by the first supply chain entity based on the obtained verified entity information 356 for the second supply chain entity. For example, rights verification component 712 can determine, based on the obtained verified entity information 356 for the second supply chain entity, that that the second supply chain entity has granted the first supply chain entity a license for retail use of products or services having the “Acme” trademark. In response to rights verification component 712 determining that the second supply chain entity has granted the first supply chain entity a license for retail use of the products or services, rights verification component 712 can determine that the first supply chain entity is authorized to add the product and/or service to the supply chain, in accordance with the license (and method 600 can proceed to block 620). If the request from client device 106N to add the product and/or service is beyond the scope of the license and/or is associated with another supply chain entity that does not have a license or other authorization to add the product and/or service to the supply chain, rights verification component 712 can determine that the first supply chain entity and/or the other supply chain entity is not authorized to add the product and/or service to the supply chain (and method 600 can proceed to block 622).

Referring back to FIG. 6, at block 620, processing logic can transmit a notification indicating that the first supply chain entity is authorized to add the product and/or service to the supply chain. In some embodiments, processing logic (e.g., supply chain component 714) can transmit the notification to client device 106N in response to the request received by entity validation platform 120. In additional or alternative embodiments, processing logic can transmit the notification to another client device 106 associated with the first supply chain entity, the second supply chain entity, and/or another supply chain entity or supply chain authority (e.g., via network 104). In some embodiments, the supply chain is part of a global supply chain (e.g., a supply chain across one or more geographic locations or across one or more markets. The request from client device 106N can be received in response to the product and/or service being received by the supply chain authority following transit through another supply chain (e.g., of the global supply chain). The request to add the product and/or service to the supply chain can correspond to a request to allow the product and/or service to continue through one or more remaining portions of the global supply chain, in some embodiments. The supply chain authority can allow the product and/or service to be added to the supply chain in response to the notification received from entity validation platform 120, in some embodiments.

Referring back to FIG. 6, at block 622, processing logic can transmit a notification indicating that the first supply chain entity is not authorized to add the product and/or service to the supply chain. In some embodiments, processing logic (e.g., supply chain component 714) can transmit the notification to client device 106N in response to the request received by entity validation platform 120 and/or to another client device 106 associated with the first supply chain entity, the second supply chain entity, etc. As described above, the supply chain can be part of a global supply chain, in some embodiments. In such embodiments, the notification can further include an indication that the product and/or service is to be removed from the global supply chain (e.g., temporarily, permanently, etc.).

In some embodiments, identifier registration engine 160 and/or identifier validation engine 180 (or another component or engine of entity validation platform 120) can update entity validation database 122 based on the request received from client device 106N. For example, identifier registration engine 160 and/or identifier validation engine 180 can update verified entity information 356 of an entry associated with the first supply chain entity and/or the second supply chain entity to indicate a time period during which the request was received from client device 106N, a geographic location associated with client device 106N, and an outcome or response to the request (e.g., whether the product or service was added to or removed from the supply chain). In some embodiments, the information used to update the entity validation database 122 can be added as a respective data block of a blockchain in accordance with previously described embodiments. The update to entity validation database 122 can be used by entity validation platform 120 to validate one or more future requests associated with products and/or services of the first supply chain entity and/or the second supply chain entity, in some embodiments.

It should be noted that, in some embodiments, information validated by entity validation platform 120 can be made available to other platforms or applications that are accessible to entity validation platform 120 (e.g., via network 104 or another network). In an illustrative example, entity validation platform 120 can receive a request from another platform or an application for validation of information associated with an entity (e.g., a supply chain entity). Entity validation platform 120 can validate the information according to embodiments of the present disclosure and can provide an indication of whether the information is valid or is not valid, in response to the request. In some embodiments, the indication of whether the information is valid or not valid can be provided in response to the request without data or information from validation platform 120 that was accessed to validate the information.

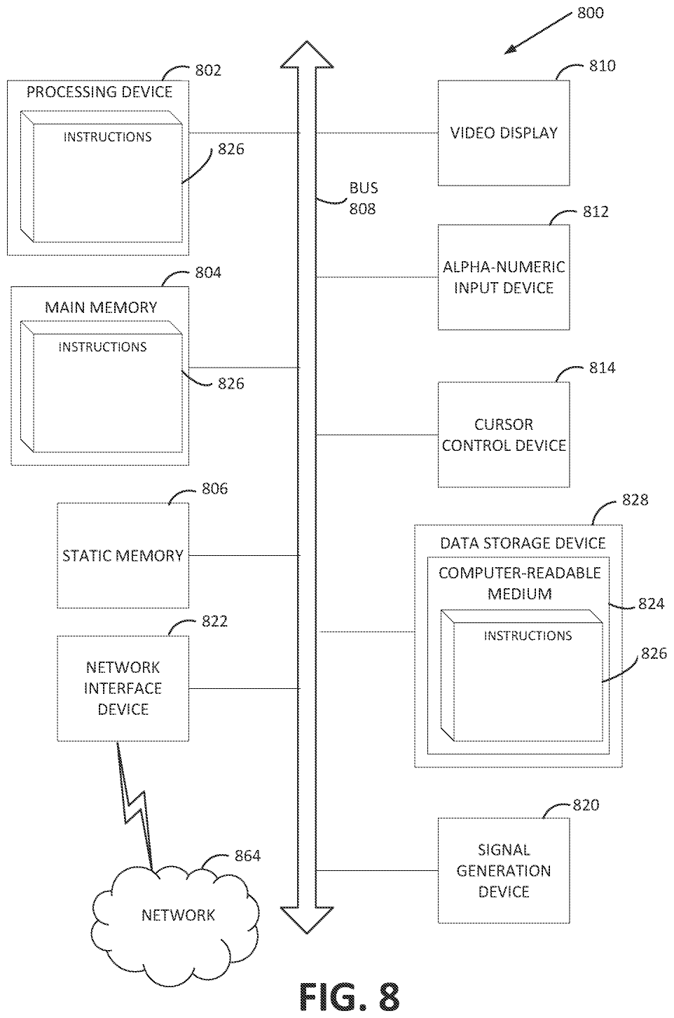

FIG. 8 is a block diagram illustrating a computer system 800, according to certain embodiments. FIG. 8 illustrates a diagrammatic representation of a machine in the example form of a computing device 800 within which a set of instructions, for causing the machine to perform any one or more of the methodologies discussed herein, can be executed. In alternative embodiments, the machine can be connected (e.g., networked) to other machines in a Local Area Network (LAN), an intranet, an extranet, or the Internet. The machine can operate in the capacity of a server or a client machine in a client-server network environment, or as a peer machine in a peer-to-peer (or distributed) network environment. The machine can be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein. In embodiments, computing device 800 can correspond to any of client device 106, platform 120, server machine 130 and/or server machine 140 of FIG. 1.

The example computing device 800 includes a processing device 802, a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.), and a secondary memory (e.g., a data storage device 828), which communicate with each other via a bus 808.

Processing device 802 can represent one or more general-purpose processors such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. Processing device 802 can also be or include a system on a chip (SoC), programmable logic controller (PLC), or other type of processing device. Processing device 802 is configured to execute the processing logic (instructions 826) for performing operations and steps discussed herein.

The computing device 800 can further include a network interface device 822 for communicating with a network 864. The computing device 800 also can include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker).

The data storage device 828 can include a machine-readable storage medium (or more specifically a non-transitory computer-readable storage medium) 824 on which is stored one or more sets of instructions 826 embodying any one or more of the methodologies or functions described herein. Wherein a non-transitory storage medium refers to a storage medium other than a carrier wave. The instructions 826 can also reside, completely or at least partially, within the main memory 804 and/or within the processing device 802 during execution thereof by the computer device 800, the main memory 804 and the processing device 802 constituting computer-readable storage media.

While the computer-readable storage medium 824 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure can be practiced without these specific details. In other instances, well-known components or methods are not described in detail or are presented in simple block diagram format in order to avoid unnecessarily obscuring the present disclosure. Thus, the specific details set forth are merely exemplary. Particular implementations can vary from these exemplary details and still be contemplated to be within the scope of the present disclosure.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.” When the term “about” or “approximately” is used herein, this is intended to mean that the nominal value presented is precise within ±10%.

Although the operations of the methods herein are shown and described in a particular order, the order of operations of each method can be altered so that certain operations can be performed in an inverse order so that certain operations can be performed, at least in part, concurrently with other operations. In another embodiment, instructions or sub-operations of distinct operations can be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
maintaining, by an entity validation platform, a database of unique identifiers for entities associated with one or more supply chains, wherein each unique identifier can be used to validate an identity associated with a respective entity associated with the one or more supply chains;
receiving, by the entity validation platform, a request for assignment of a unique identifier for a supply chain entity, wherein the request includes information associated with the supply chain entity, the information comprising at least an indication of a name associated with the supply chain entity and an indication of at least one of a product or a service associated with the supply chain entity;
validating, by the entity validation platform and for the supply chain entity, an entity ownership structure associated with the supply chain entity and a geographic location where the supply chain entity is operating, wherein at least one of the entity ownership structure or the geographic location is validated based on verified information included in one or more additional databases accessible by the entity validation platform, wherein the verified information included in the one or more additional databases is verified by one or more trusted supply chain information entities; and
responsive to validating the entity ownership structure and the geographic location for the supply chain entity, updating, by the entity validation platform, the database to assign the unique identifier to the supply chain entity, wherein updating the database to assign the unique identifier to the supply chain entity indicates to a supply chain authority accessing the database that the supply chain entity is a validated supply chain entity that can participate in the one or more supply chains.

2. The method of claim 1, further comprising:
validating an intellectual property ownership status of the at least one of the product or the service by the supply chain entity, wherein validating the intellectual property ownership status comprises comparing at least the indication of the name associated with the supply chain entity and the indication of the at least one or more of the product or the service to the verified information included in the one or more additional databases.

3. The method of claim 1, wherein validating the entity ownership structure and the geographic location for the supply chain entity further comprises:
providing the indication of the name associated with the supply chain entity and the indication of at least one of the product or the service associated with the supply chain entity as input to a machine learning model, wherein the machine learning model is trained to predict, based on given entity data, a likelihood of whether a respective supply chain entity requesting assignment of the unique identifier for the respective supply chain entity is at least one of a fraudulent supply chain entity or an entity that is engaged in one or more dishonorable practices;
obtaining one or more outputs of the machine learning model;
determining, based on the obtained one or more outputs, a level of confidence that the supply chain entity is the at least one of the fraudulent supply chain entity or the entity that is engaged in one or more dishonorable practices;
determining that the determined level of confidence satisfies one or more confidence criteria.

4. The method of claim 3, wherein the machine learning model is trained based on historical data indicating a historical supply chain activity by one or more additional supply chain entities and one or more supply chain conditions satisfied or violated by the historical supply chain activity by the one or more additional supply chain entities.

5. The method of claim 1, wherein the database corresponds to a blockchain, and wherein updating the database to include the unique identifier for the supply chain entity comprises:
appending the unique identifier to a data block of the blockchain; and
broadcasting the data block of the blockchain to a plurality of blockchain nodes.

6. The method of claim 5, further comprising:
appending data indicating the validated entity ownership structure and the validated geographic location for the supply chain entity to the data block of the blockchain.

7. The method of claim 1, further comprising:
responsive to updating the database to assign the unique identifier to the supply chain entity, obtaining updated information associated with the supply chain entity, wherein the updated information is obtained from at least one of the supply chain entity or the one or more additional databases accessible by the entity validation platform;
determining whether the supply chain entity is a valid entity based on the obtained information; and
responsive to determining that the supply chain entity is not a valid entity based on the obtained information, performing at least one of:
removing the assignment of the unique identifier to the supply chain entity from the database, or
updating the database to indicate that the supply chain entity is not a valid entity.

8. The method of claim 1, wherein the request for the assignment of the unique identifier for the supply chain entity is received from at least one of a computing system associated with the supply chain entity or a computing system associated with another entity that is different from the supply chain entity.

9. A system comprising:
a memory; and
a processor connected to the memory, wherein the processor is to perform operations comprising:
receiving, from a client device connected to an entity validation platform, a request for at least one of a product or a service to be added to a supply chain by a first supply chain entity, wherein the request comprises a first unique identifier issued to the first supply chain entity by the entity validation platform;
identifying an entry of an entity validation database that corresponds to the at least one of the product or the service, wherein the entity validation database is maintained by the entity validation platform;
determining whether the first unique identifier issued to the first supply chain entity corresponds to a second unique identifier for a second supply chain entity indicated by the identified entry of the entity validation database;
responsive to determining that the first unique identifier does not correspond to the second unique identifier, obtaining information associated with the second supply chain entity, wherein the information corresponds to at least one of an entity ownership structure associated with the second supply chain entity, an intellectual property ownership status associated with the second supply chain entity with respect to the at least one of the product or the service, one or more activities of the second supply entity within the supply chain, and a geographic location at which the second supply chain entity is operating;
determining, based on the obtained information, whether the first supply chain entity is authorized to add the at least one of the product or the service to the supply chain; and
responsive to determining that the first supply chain entity is not authorized to add the at least one of the product or the service to the supply chain, transmitting a notification to the client device indicating that the first supply chain entity is not authorized to add the at least one of the product or the service to the supply chain.

10. The system of claim 9, wherein the entity validation database corresponds to a blockchain, and wherein the identified entry of the entity validation database corresponds to a data block of the blockchain.

11. The system of claim 10, further comprising:
appending data indicating the request for the at least one of the product or the service to be added to the supply chain by the first supply chain entity to a data block of the blockchain; and
broadcasting the data block of the blockchain to a plurality of blockchain nodes.

12. The system of claim 10, wherein the block chain is a public blockchain or a private blockchain.

13. The system of claim 9, wherein obtaining the information associated with the second supply chain entity comprises:
extracting the information from the identified entry of the entity validation database.

14. The system of claim 9, further comprising:
responsive to determining that at least one of the first unique identifier does corresponds to the second unique identifier or the first supply chain entity is authorized to add the at least one of the product or the service to the supply chain, transmitting a notification to the client device indicating that the at least one of the product or the service can be added to the supply chain by the first supply chain entity.

15. The system of claim 9, where in the supply chain is part of a global supply chain that includes the at least one of the product or the service, and wherein the notification further indicates that the at least one of the product or the service is to be removed from the global supply chain.

16. A non-transitory computer-readable medium comprising instructions that, when executed by a processing device, cause the processing device to perform operations comprising:
maintaining a database of unique identifiers for entities associated with one or more supply chains, wherein each unique identifier can be used to validate an identity associated with a respective entity associated with the one or more supply chains;
receiving a request for assignment of a unique identifier for a supply chain entity, wherein the request includes information associated with the supply chain entity, the information comprising at least an indication of a name associated with the supply chain entity and an indication of at least one of a product or a service associated with the supply chain entity;
validating, for the supply chain entity, an entity ownership structure associated with the supply chain entity and a geographic location where the supply chain entity is operating, wherein at least one of the entity ownership structure or the geographic location is validated based on verified information included in one or more additional databases accessible by an entity validation platform, wherein the verified information included in the one or more additional databases is verified by one or more trusted supply chain information entities; and
responsive to validating the entity ownership structure and the geographic location for the supply chain entity, updating the database to assign the unique identifier to the supply chain entity, wherein the updating the database to assign the unique identifier to the supply chain entity indicates to a supply chain authority accessing the database that the supply chain entity is a validated supply chain entity that can participate in the one or more supply chains.

17. The non-transitory computer-readable medium of claim 16, wherein the operations further comprise:
validating an intellectual property ownership status of the at least one of the product or the service by the supply chain entity, wherein validating the intellectual property ownership status comprises comparing at least the indication of the name associated with the supply chain entity and the indication of the at least one or more of the product or the service to the verified information included in the one or more additional databases.

18. The non-transitory computer-readable medium of claim 16, wherein validating the entity ownership structure and the geographic location for the supply chain entity further comprises:
providing the indication of the name associated with the supply chain entity and the indication of the at least one of the product or the service associated with the supply chain entity as input to a machine learning model, wherein the machine learning model is trained to predict, based on given entity data, a likelihood of whether a respective supply chain entity requesting assignment of the unique identifier for the respective supply chain entity is at least one of a fraudulent supply chain entity or an entity that is engaged in one or more dishonorable practices;
obtaining one or more outputs of the machine learning model;
determining, based on the obtained one or more outputs, a level of confidence that the supply chain entity is the at least one of the fraudulent supply chain entity or the entity that is engaged in one or more dishonorable practices;
determining that the determined level of confidence satisfies one or more confidence criteria.

19. The non-transitory computer-readable medium of claim 18, wherein the machine learning model is trained based on historical data indicating a historical supply chain activity by one or more additional supply chain entities and one or more supply chain conditions violated by the historical supply chain activity by the one or more additional supply chain entities.

20. The non-transitory computer-readable medium of claim 16, wherein the database corresponds to a blockchain, and wherein updating the database to include the unique identifier for the supply chain entity comprises:
appending the unique identifier to a data block of the blockchain; and
broadcasting the data block of the blockchain to a plurality of blockchain nodes.
